(19) United States
(12) Patent Application Publication
(10) Pub. No.: US 2014/0113098 A1
(43) Pub. Date: Apr. 24, 2014

(54) SPACER HAVING A DESICCANT

(71) Applicant: Guartdian IGU, LLC, White Bear Lake, MN (US)

(72) Inventors: David Rapp, Eden Prairie, MN (US); Kurt E. Heikkila, Marine on the St. Croix, MN (US); Raimo T. Nieminen, Lempaala (FI)

(73) Assignee: Guartdian IGU, LLC, White Bear Lake, MN (US)

(21) Appl. No.: 14/058,549

(22) Filed: Oct. 21, 2013

Related U.S. Application Data
(60) Provisional application No. 61/716,861, filed on Oct. 22, 2012.

(51) Int. Cl. E06B 3/663

(52) U.S. Cl. CPC E06B 3/66361
USPC 428/76; 96/118; 156/279

(57) ABSTRACT

The technology described herein relates to a composition having a layer of substrate with a first surface and a second surface distinct from the first surface. A plurality of adsorbent beads is embedded in the second surface of the substrate. Each adsorbent bead of the plurality of adsorbent beads is no more than partially embedded in the second surface of the substrate and the substrate is substantially free of adsorbent beads.

### RELATED APPLICATIONS

This application is a non-provisional of “SPACER HAVING A DESICCANT,” U.S. Ser. No. 61/716,861, filed Oct. 22, 2012 (Atty. Docket No. 724.0031USP1), which is incorporated herein by reference in its entirety.

This application is related to the following U.S. patent applications: “TRIPLE PANE WINDOW SPACER, WINDOW ASSEMBLY AND METHODS FOR MANUFACTURING SAME”, U.S. 2012/0151857, filed Dec. 15, 2011 (Atty. Docket No. 724.0017USU1); “SEALED UNIT AND SPACER”, U.S. 2009/0120035, filed Nov. 13, 2008 (Atty. Docket No. 724.0009USU1); “BOX SPACER WITH SIDEWALLS”, U.S. 2009/0120036, filed Nov. 13, 2008 (Atty. Docket No. 724.0012USU1); “REINFORCED WINDOW SPACER”, U.S. 2009/0120019, filed Nov. 13, 2008 (Atty. Docket No. 724.0011USU1); “SEALED UNIT AND SPACER WITH STABILIZED ELONGATE STRIP”, U.S. 2009/0120018, filed Nov. 13, 2008 (Atty. Docket No. 724.0013USU1); “MATERIAL WITH UNDULATING SHAPE” U.S. 2009/0123694, filed Nov. 13, 2008 (Atty. Docket No. 724.0014USU1); and “STRETCHED STRIPS FOR SPACER AND SEALED UNIT”, U.S. 2011/0104512, filed Jul. 14, 2010 (Atty. Docket No. 724.0015USU1); “WINDOW SPACER APPLICATOR”, U.S. 2011/0303349, filed Jun. 10, 2011 (Atty. Docket No. 724.0016USU1); “WINDOW SPACER, WINDOW ASSEMBLY AND METHODS FOR MANUFACTURING SAME”, U.S. Provisional Patent Application Ser. No. 61/386,732, filed Sep. 27, 2010 (Atty. Docket No. 724.0008USP1); “SPACER JOINT STRUCTURE”, US-2013-0042552-A1, filed on Oct. 22, 2012 (Atty. Docket No. 724.0009USI1); “ROTATING SPACER APPLICATOR FOR WINDOW ASSEMBLY”, US 2013/0047404, filed on Oct. 22, 2012 (Atty. Docket No. 724.0016USI1); “ASSEMBLY EQUIPMENT LINE AND METHOD FOR WINDOWS”, filed on Oct. 21, 2013 (Atty. Docket No. 724.0032USU1); “TRIPLE PANE WINDOW SPACER HAVING A SUNKEN INTERMEDIATE PANE”, filed on Oct. 21, 2013 (Atty. Docket No. 724.0034USU1), which are all hereby incorporated by reference in their entirety.

### FIELD OF THE INVENTION

Generally, the technology disclosed herein relates to a window spacer. More particularly, the technology disclosed herein relates to a spacer having a desiccant.

### BACKGROUND

Multiple pane insulating glass (IG) structures or windows have many variations in their design. Most designs have two or more panes of glass which are held in a spaced relationship by a spacer, which is located between the panes and near their edges. The spacer and panes are typically held together by a sealant or other means. The spacer and panes thereby define a closed interior space in the IG, which is largely responsible for the insulating benefit associated with the structure.

Typically, when the IG structure is sealed, some water vapor remains in the resulting closed interior space. If no measures are taken, this water vapor would condense on the panes when the unit is exposed to typical service temperatures thereby causing fogging. A similar effect may occur if materials used to construct the IG structure contain volatile organic compounds (VOCs) which can pass to the interior space of the unit. To prevent fogging, most IG designs provide a means for adsorbing water vapor/chemical volatiles in the interior space over the expected life of the IG unit.

In some conventional designs of IG structures, one or more compartments are located at the periphery of the interior space either in the spacer itself or adjacent to the spacer. The compartment(s) is adapted to contain adsorbent materials (typically desiccants) in bead form or a polymeric matrix form in a manner such that the adsorbent beads or matrix communicate with the interior space to provide an adsorbing function for that space while the beads or matrix are retained in the compartment(s). In other conventional designs of IG structures, the spacer structure itself includes adsorbent materials. Thus fogging due to water vapor and/or VOCs is prevented.

The beads used alone for this type of application generally consist of one or more types of molecular sieve bound by an inorganic binder (typically clay), silica gel, or activated charcoal. The beads are designed to be free-flowing. Thus, they can easily be poured into the compartment to provide the desired quantity of desiccant. Example beaded desiccant is manufactured by W.R. Grace & Co. based in Columbia, Md. While this basic IG technology has been for many years the conventional solution, adsorbent beads alone present handling problems especially for the window manufacturer. Specifically, options for positioning and containing the beaded desiccant are limited. The desire to avoid the problem has led to alternative designs that avoid the use of beaded desiccants use of desiccated adhesive or matrix resins that are adhered directly to specially designed spacers and/or by use of special spacer constructions whereby the spacer is formed in part by a desiccated resin. These alternatives are expensive both from the point of raw materials cost and from the point of capital cost associated with the purchase of equipment needed to implement the alternatives.

### SUMMARY OF THE INVENTION

In one embodiment, a composition is taught with a layer of substrate having a first surface and a second surface distinct from the first surface. A plurality of adsorbent beads are embedded in the second surface of the substrate, and each adsorbent bead of the plurality of adsorbent beads is no more than partially embedded in the second surface of the substrate. The substrate is substantially free of adsorbent beads.

In another embodiment, the technology disclosed herein is a window spacer. A spacer structure defines a cavity, and a composition is disposed within the cavity. The composition has a plurality of adsorbent beads, wherein each adsorbent bead of the plurality of adsorbent beads has a first portion having an outer surface in contact with air, and a second portion distinct from the first portion. A substrate base layer is substantially free of adsorbent beads, and an intermediate layer has the second portion of each adsorbent bead and the substrate.

In yet another embodiment, the technology disclosed herein is a stored window spacer for an insulated glass unit containing a composition. A spacer structure for an insulated glass unit is disposed about a spool. The spacer structure defines a cavity, and a composition is disposed in the cavity. The composition has a layer of a substrate having a first surface and a layer of adsorbent beads substantially fixed to the first surface of the substrate. The adsorbent beads are an adsorbent material substantially free of substrate and the substrate is substantially free of adsorbent material.

In yet another embodiment, the technology disclosed herein is a method for forming a window spacer containing a composition. Substrate is dispensed onto a surface of a first window spacer component. The substrate is exposed to a plurality of adsorbent beads whereby a portion of the adsorbent beads adhere onto a surface of the substrate. And the window spacer is wound onto a spool.

### BRIEF DESCRIPTION OF THE DRAWINGS

The invention may be more completely understood and appreciated in consideration of the following detailed description of various embodiments of the invention in connection with the accompanying drawings.

FIG. 1 depicts a perspective view of a portion of one embodiment of a spacer having a desiccant.

FIG. 1A depicts Detail A of FIG. 1.

FIG. 1B also depicts Detail A of FIG. 1.

FIG. 1C also depicts Detail A of FIG. 1.

FIG. 2 depicts a flow chart consistent with one embodiment of the technology disclosed herein.

FIG. 3 depicts one process step consistent with the technology disclosed herein.

FIG. 4 depicts additional process steps consistent with the technology disclosed herein.

FIG. 5 depicts additional process steps consistent with the technology disclosed herein.

FIG. 6 depicts a cross-sectional view of one embodiment of a spacer having desiccant.

FIG. 7 depicts a perspective view of a portion of another embodiment of a window assembly having a spacer having desiccant.

FIG. 8 depicts a perspective view of a portion of another embodiment of a window assembly having a spacer having desiccant.

FIG. 9 depicts a perspective view of a portion of a spacer consistent with the technology disclosed herein.

### DETAILED DESCRIPTION

In a number of the embodiments presented herein, window spacer structures include a desiccant composition including a substrate and adsorbent beads, where the adsorbent beads are partially embedded into the substrate. In various embodiments, this can be accomplished by applying the substrate to a surface of the spacer then submerging the substrate in adsorbent beads or showing adsorbent beads over the substrate. In some embodiments, the adsorbent beads are pressed partially into the substrate. When the adsorbent beads are attached to the substrate, they are not free to fall within a viewing area of the window unit. Because the adsorbent beads are not completely embedded in the substrate in these embodiments, the adsorbent surface area is more available to adsorb water vapor, VOCs or both within an interior space of a window unit.

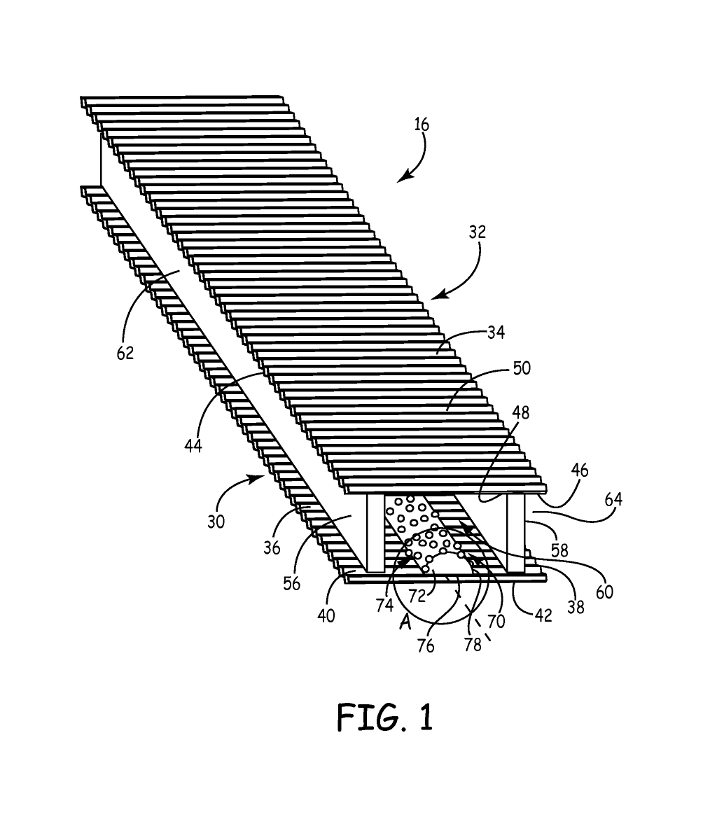

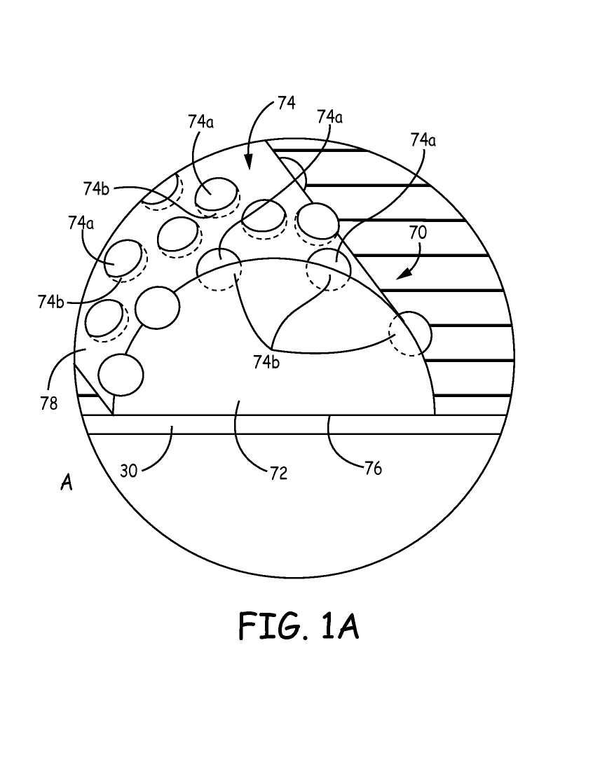

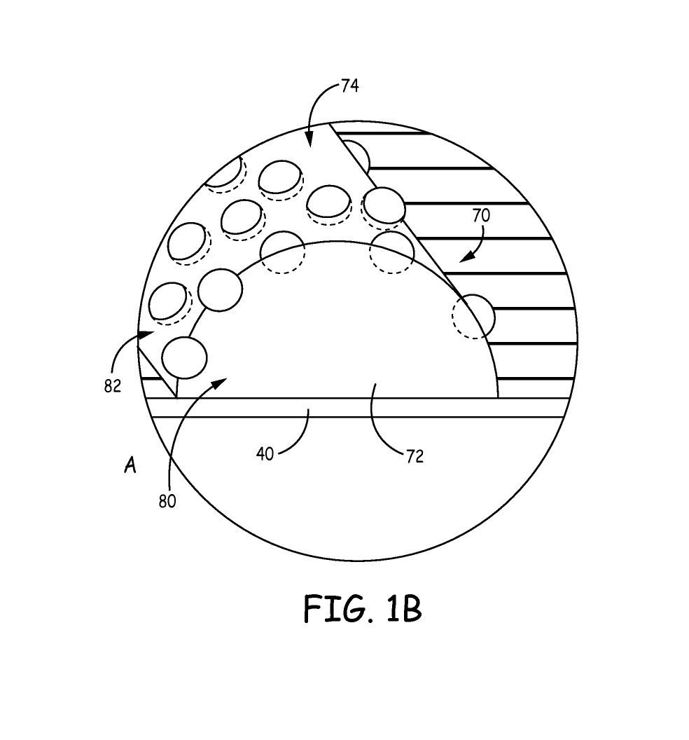

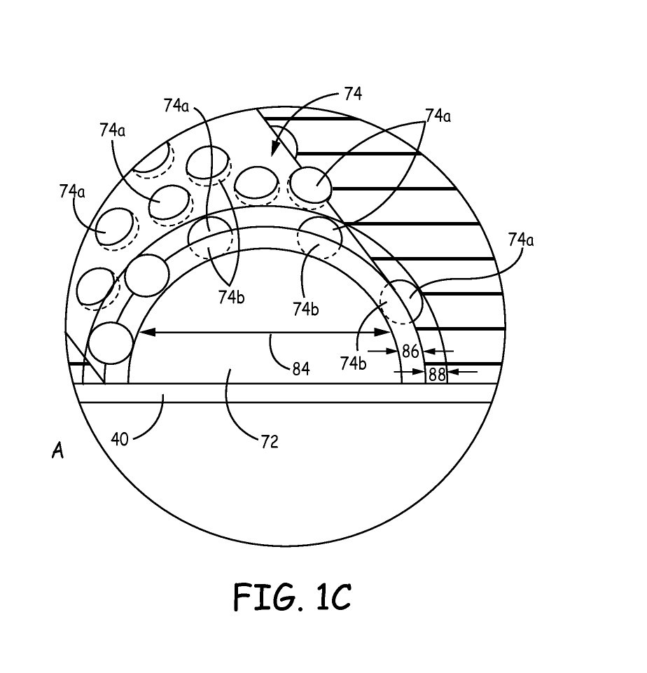

FIG. 1 depicts a perspective view of a portion of one embodiment of a spacer 16 having a desiccant composition 70. The spacer 16 is generally configured for use within an insulated glass unit. The structure of the spacer 16 generally defines a cavity 60 with a composition 70 disposed within the cavity 60.

In the current embodiment the structure of the spacer 16 has a first elongate strip 30, a second elongate strip 32, a first longitudinal wall 56, and a second longitudinal wall 58, where the cavity 60 is defined by the first elongate strip 30, the second elongate strip 32, the first longitudinal wall 56, and the second longitudinal wall 58.

In one embodiment, the first and second elongate strips 30, 32 are formed from a metal material or a plastic material. In at least one embodiment the first and second elongate strips 30, 32 are constructed of stainless steel. An example of a suitable plastic is a thermoplastic polymer, such as polyethylene terephthalate. In at least one embodiment, the first elongate strip 30 is constructed of a different material than the second elongate strip 32. In other embodiments, the first elongate strip 30 and the second elongate strip 32 are constructed of substantially similar materials. The thickness of the material of the first and second elongate strips 30, 32 can range from at least about 0.001 inch (0.025 mm) to about 0.006 inch (0.15 mm) in various embodiments.

The first and second elongate strips 30, 32 are generally flexible in both bending and torsion. In some embodiments, bending flexibility allows the spacer 16 to be bent to form non-linear shapes (e.g., curves). Bending and torsional flexibility also allows for ease of window manufacturing. Such flexibility includes either elastic or plastic deformation such that the first and second elongate strips 30, 32 do not fracture during installation into window assembly. In a variety of embodiments, the spacer 16 is flexible such that its length can be stored on a spool without damage. In such an embodiment, the spacer 16 can have the flexibility to be wrapped around a mandrel having at least an eighteen-inch diameter without damage. In another such embodiment, the spacer 16 can have the flexibility to be wrapped around a mandrel having at least a ten-inch diameter without damage. In yet another such embodiment, the spacer 16 can have the flexibility to be wrapped around a mandrel having at least a four-inch diameter without damage.

Some embodiments of spacer 16 include elongate strips that do not have substantial flexibility, but rather are substantially rigid. In some embodiments, the first and second elongate strips 30, 32 are flexible, but the resulting spacer 16 is substantially rigid.

In a variety of embodiments, the first elongate strip 30 and the second elongate strip 32 define lateral undulations 34, respectively, where the term “lateral” is defined as a direction perpendicular to the length of the elongate strip. In one embodiment, the undulations 34 are arcuate in shape. In another embodiment, the undulations 34 have one of a sinusoidal, square, rectangular, triangular or other shape. In at least one embodiment just one of either the first elongate strip 30 or the second elongate strip 32 defined lateral undulations. In at least another embodiment, neither of the first elongate strip 40 or the second elongate strip 50 define lateral undulations.

In one embodiment, the undulations 34 are adapted to provide flexibility to the first and second elongate strips 30, 32. In another embodiment, the undulations 34 are adapted to resist permanent deformation (e.g., kinks, fractures, etc.). In another embodiment, the undulations 34 may also increase the structural stability of the first and second elongate strips 30, 32 and improve the ability of the spacer 16 to withstand compressive and torsional loads.

The first elongate strip 30 includes a first side portion 36 and an oppositely disposed second side portion 38. The first elongate strip 30 further includes a first surface 40 and an oppositely disposed second surface 42. Likewise, the second elongate strip 32 includes a first side portion 44 and an oppositely disposed second side portion 46. The second elongate strip 32 further includes a first surface 48 and an oppositely disposed second surface 50.

The spacer 16 includes a first longitudinal wall 56 and a second longitudinal wall 58. The first and second longitudinal walls 56, 58 extend between the first elongate strip 30 and the second elongate strip 32. The first and second longitudinal walls 56, 58 generally are configured to provide a uniform or substantially uniform spacing between elongate strips 30, 32 to maintain the elongate strips 30, 32 in a parallel or substantially parallel orientation. In a variety of embodiments, the first longitudinal wall 56 and second longitudinal wall 58 are substantially parallel to each other. The first and second longitudinal walls 56, 58 are substantially continuous in multiple embodiments and are arranged at intermediate positions between parallel elongate edges of the elongate strips 30, 32. In the depicted embodiment, the first longitudinal wall 56 is engaged to the first side portion 36 on the first surface 40 of the first elongate strip 30 and the first side portion 44 on the first surface 48 of the second elongate strip 32. In one embodiment, the first and second longitudinal walls 56, 58 extend the length of the first and second elongate strips 30, 32.

Each of the first and second elongate strips 30, 32 includes a first elongate edge and a second elongate edge. The first elongate edge is at the edge of the first side portion 36, 44 of each strip and the second elongate edge is at the edge of the second side portion 38, 46 of each strip. The first longitudinal wall 56 is closer to the first side portion 36, 44 of each strip 30, 32 than to the second side portion 38, 46 of each strip 30, 32. The first longitudinal wall 56 is offset from the first edge of the first elongate strip 30 and from the first edge of the second elongate strip 32 by a first offset distance. The second longitudinal wall 58 is closer to the second side portion 38, 46 of each strip 30, 32 than to the first side portion 36, 44 of each strip 30, 32. The second longitudinal wall 58 is offset from the second edge of the first elongate strip and from the second edge of the second elongate strip by a second offset distance that will be substantially similar to the first offset distance.

In one embodiment, the support legs are constructed of a material having mechanical properties so that the support legs can withstand compressive forces and assist with maintaining the desired rigidity of the spacer. The support legs maintain the substantially parallel orientation of the elongate strips during the window assembly process and to some degree in the finished window assembly. In one embodiment, the first and second longitudinal walls 56, 58 are constructed from a plastic material. The plastic material can be rolled or molded to form the first and second longitudinal wall 56, 58. In a variety of embodiments, the plastic material is extruded on the first elongate strip 30 or the second elongate strip 32 to form a sidewall. In a variety of embodiments, the first and second longitudinal wall 56, 58 are constructed of nylon, although those having skill in the art will appreciate other materials that would also be suitable.

The first side portion 36 of the first elongate strip 30, the first longitudinal wall 56 and the first side portion 44 of the second elongate strip 32 cooperatively define a first side channel 62 of the spacer 16. The second side portion 38 of the first elongate strip 30, the second longitudinal wall 58 and the second side portion 46 of the second elongate strip 32 cooperatively define a second side channel 64 of the spacer 16.

### Desiccant

The composition 70 disposed within the cavity 60 generally has a substrate 72 and a plurality of adsorbent beads 74. In a variety of embodiments, the adsorbent beads 74 are made of an adsorbent material. Generally, the material of the adsorbent beads 74 is substantially free of substrate 72 and the substrate 72 is substantially free of adsorbent material.

The substrate 72 has a first surface 76 in contact with the first elongate strip 30 and a second surface 78 distinct from the first surface 76. In a variety of embodiments, the surface area of the second surface 78 is greater than the surface area of the first surface 76. The plurality of adsorbent beads 74 are generally embedded in the second surface 78 of the substrate 72. In a variety of embodiments, each adsorbent bead of the plurality of adsorbent beads 74 is no more than partially embedded in the second surface 78 of the substrate 72. As such, the substrate 72 is generally substantially free of adsorbent beads.

FIG. 1A depicts Detail A from FIG. 1. Each adsorbent bead of the plurality of absorbent beads 74 has a first portion 74a with an outer surface in contact with air, and a second portion 74b that is distinct from the first portion 74a. In multiple embodiments, the plurality of adsorbent beads 74 are on average at least about 50% exposed.

The composition 70 can be characterized as having two layers, depicted in FIG. 1B. A substrate layer 80, and an adsorbent bead layer 82 having a plurality of adsorbent beads 74 that are substantially fixed to a surface of the substrate 72. The composition 70 can also be characterized as having three layers, depicted in FIG. 1C. A substrate base layer 84 is defined by the substrate 72. An intermediate layer 86 is defined by the second portion of each adsorbent bead 74b and the substrate 72. A top layer 88 is defined by the first portion of each adsorbent bead 74a and air.

### Substrate

The substrate 80 is generally configured to maintain the placement of the adsorbent beads. The substrate 80 can be a variety of materials and combinations of materials. In a variety of embodiments, the substrate 80 directly adheres to the adsorbent beads, and in a variety of other embodiments, the substrate 80 mechanically attaches to the adsorbent beads. The substrate can generally be any type of adhesive material. As used herein, the term “adhesive material” is defined as any material that chemically hardens and is from natural or synthetic origins. Examples of synthetic substrates are acrylics, silicones, urethanes etc. Examples of natural substrates include starches, collagen, natural resin, and the like.

The substrate 80 can include a matrix material, and can have a desiccant disposed within. Examples of matrix desiccants include those manufactured by W.R. Grace & Co. based in Columbia, Md. and H.B. Fuller Company based in Saint Paul, Minn. One particular example matrix material is HL-5157 produced by H.B. Fuller Company. In one embodiment, the substrate 80 can have layers of beaded desiccant distributed within the substrate 80. In such an embodiment, each layer of beaded desiccant can have a thickness of at least one bead.

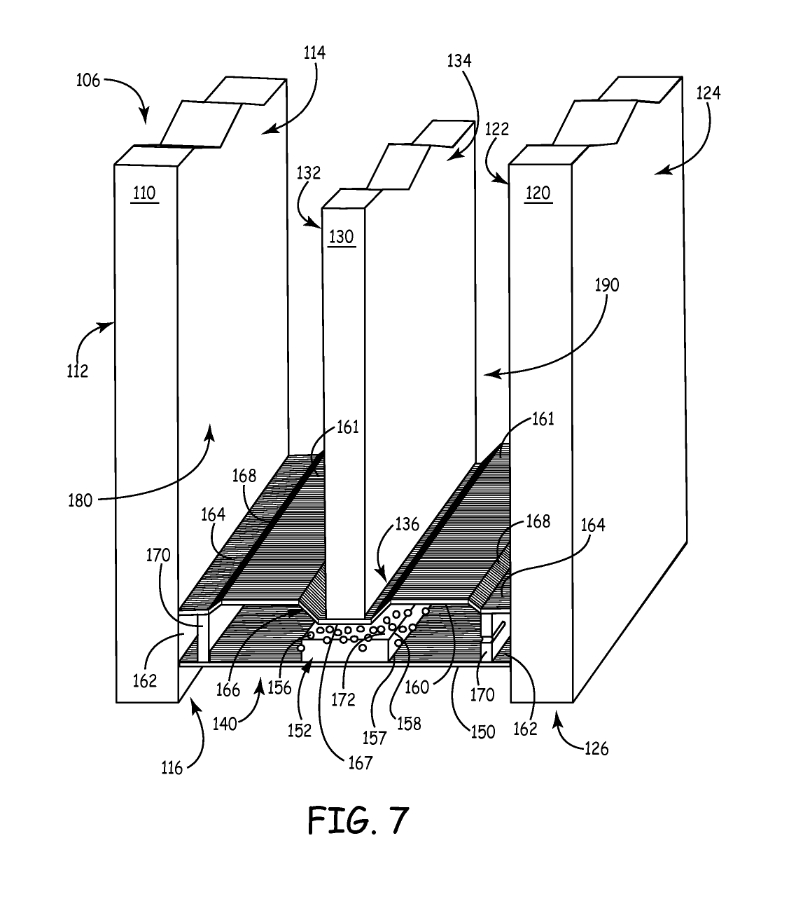

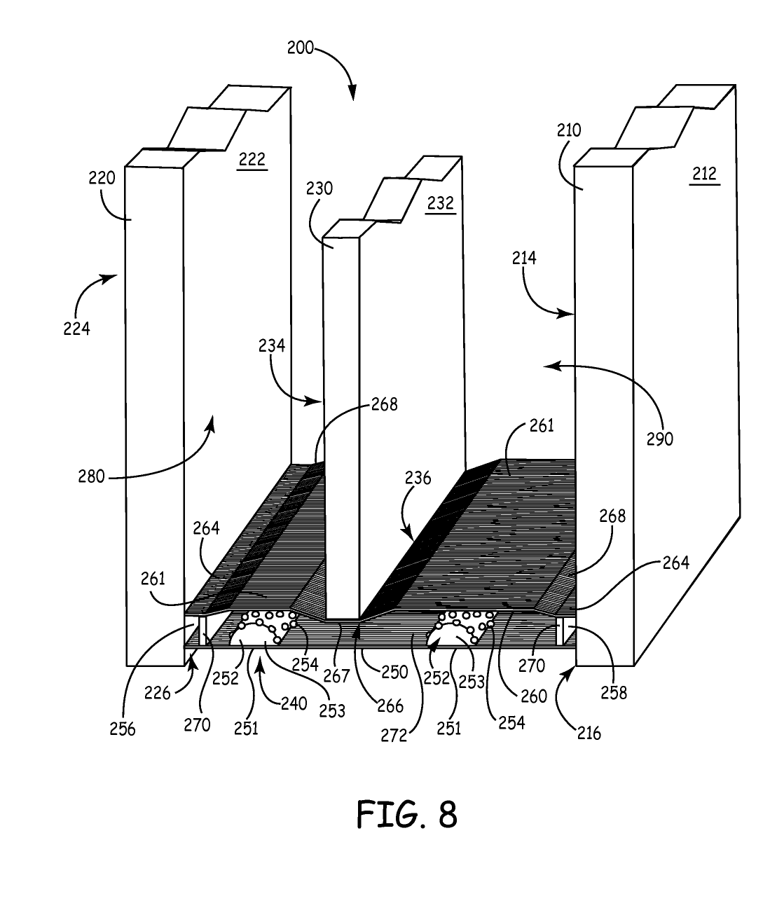

In a variety of embodiments, the substrate 80 is also configured to provide an increased surface area exposed to receive adsorbent beads compared to the surface area of the substrate in contact with the elongate strip, thereby increasing the relative number of adsorbent beads. As such, the surface area of the substrate in contact with the elongate strip is less than the surface area of the substrate that is not in contact with the elongate strip. The substrate 80 can be a variety of shapes, although it is depicted in FIGS. 1-1c as having a semi-circle cross-section. In one alternate example, the substrate has a tubular cross section. FIGS. 7 and 8 depict other example shapes of the substrate, and those having skill in the art will appreciate that other shapes can also be used.

### Adsorbent Beads

The adsorbent beads 74 can have a wide variety of shapes and sizes. While in the current FIGS. 1-1(c) the beads are depicted as substantially spherical, those having skill in the art will recognize that other three-dimensional shapes are possible, including irregular shapes. The adsorbent beads can also have varying shapes and sizes, despite being depicted as having a consistent shape and size in the current figures.

The term “bead” as used herein is defined as including terms such as granules, particles, pieces, and the like. In at least one embodiment, the adsorbent beads 74 can be particles having a size consistent with a powder. The adsorbent beads will generally have a size of less than 2.5 mm in diameter. Beads can range in size from about 0.5 mm to about 0.9 mm in diameter, about 0.8 mm to about 1.6 mm in diameter, and about 0.8 mm to about 2.0 mm in diameter.

In a variety of embodiments, the weight of the adsorbent beads 74 can range from 75% to 200% of the weight of the substrate 80. In some of those embodiments, the weight of the adsorbent beads can range from 75% to about 100%. In at least one embodiment, the ratio of adsorbent beads to substrate is about 1:1 by weight.

The adsorbent beads 74 generally are constructed of one or more adsorbent materials. Useful inorganic material to form beaded desiccant can include material such as activated charcoal, silica gel or zeolites. In one embodiment, zeolites are the material used to form the beaded desiccant material. Depending on the pore size, zeolites may be effective entrapping either water vapor or VOCs. Organic material such as cyclodextrin may be used to form beads that are effective at entrapping VOCs. Combinations of inorganic and organic beads may be formed as mixtures in an embodiment.

Methods for forming adsorbent beads are known in the art.

### Zeolites

Zeolites are microporous crystalline solids with well-defined structures. Generally they contain silicon, aluminum and oxygen in their framework and cations, water and/or other molecules may be trapped within their pores. Because of their unique porous properties, zeolites are used in a variety of applications with a global market of several million tonnes per annum. In the western world, major uses are in petrochemical cracking, ion-exchange (water softening and purification), and in the separation and removal of gases and solvents.

Zeolites are aluminosilicate members of a family of microporous solids known as molecular sieves. The term “molecular sieve” refers to a particular property of these materials, i.e., the ability to selectively sort molecules based primarily on a size exclusion process. This is due to a very regular pore structure of molecular dimensions. The maximum size of the molecular or ionic species that can enter the pores of a zeolite is controlled by the dimensions of the pore channels. These are conventionally defined by the ring size of the aperture, where, for example, the term “8-ring” refers to a closed loop that is built from 8 tetrahedrally coordinated silicon (or aluminum) atoms and 8 oxygen atoms. These rings are not always perfectly symmetrical due to a variety of chemical and physical effects. Therefore, the pores in many zeolites are not perfectly cylindrical.

There are several types of synthetic zeolites that are formed by a process of slow crystallization of a silica-alumina gel in the presence of alkalis and organic templates. One of the important processes used to carry out zeolite synthesis is sol-gel processing. A sol-gel product's properties depend on reaction mixture composition, pH of the system, operating temperature, pre-reaction ‘seeding’ time, reaction time as well as the templates used. In a sol-gel process, other elements (metals, metal oxides) can be easily incorporated. A silica sol formed by the hydrothermal method is very stable. Also the ease of scaling up this process makes it a favorable route for zeolite synthesis.

Synthetic zeolites hold some key advantages over their natural analogs. The synthetics can, of course, be manufactured in a uniform, phase-pure state. It is also possible to manufacture desirable zeolite structures which do not appear in nature. Zeolite A is a well-known example. The shape-selective properties of zeolites are also the basis for their use in molecular adsorption. The ability preferentially to adsorb certain molecules, while excluding others, has opened up a wide range of molecular sieving applications. Sometimes it is simply a matter of the size and shape of pores controlling access into the zeolite. In other cases different types of molecule enter the zeolite, but some diffuse through the channels more quickly, leaving others stuck behind, as in the purification of para-xylene by silicalite.

Cation-containing zeolites are extensively used as desiccants due to their high affinity for water, and also find application in gas separation, where molecules are differentiated on the basis of their electrostatic interactions with the metal ions. Conversely, hydrophobic silica zeolites preferentially absorb organic solvents. Zeolites can thus separate molecules based on differences of size, shape and polarity.

### Cyclodextrins

Cyclodextrins are also useful as a bead to capture volatile organic compounds (VOCs) from the atmosphere. Cyclodextrins are produced from starch by means of enzymatic conversion. They are used in food, pharmaceutical,[1] drug delivery,[2] and chemical industries, as well as agriculture and environmental engineering.

Cyclodextrins are composed of 5 or more α-D-glucopyranoside units linked 1->4, as in amylose. The 5-membered macrocycle is not natural. Typical cyclodextrins contain a number of glucose monomers ranging from six to eight units in a ring, creating a cone shape thus denoting 1) α-cyclodextrin: six membered sugar ring molecule, 2) β-cyclodextrin: seven sugar ring molecule or 3) γ-cyclodextrin: eight sugar ring molecule.

Typical cyclodextrins are constituted by 6-8 glucopyranoside units, can be topologically represented as toroids with the larger and the smaller openings of the toroid exposing to the solvent secondary and primary hydroxyl groups respectively. Because of this arrangement, the interior of the toroids is not hydrophobic, but considerably less hydrophilic than the aqueous environment and thus able to host other hydrophobic molecules. In contrast, the exterior is sufficiently hydrophilic to impart cyclodextrins (or their complexes) water solubility.

The formation of the inclusion compounds greatly modifies the physical and chemical properties of the guest molecule, mostly in terms of water solubility. This is the reason why cyclodextrins have attracted much interest in many fields because inclusion compounds of cyclodextrins with hydrophobic molecules are able to selectively bond with target chemicals, such as toluene and xylene, but not other compounds such as argon, an important compound in the IG industry.

The production of cyclodextrins is relatively simple and involves treatment of ordinary starch with a set of easily available enzymes. Commonly cyclodextrin glycosyltransferase (CGTase) is employed along with α-amylase.

### Other Desiccating Materials

The desiccating material component for the adsorbent beads may include other conventional hygroscopic (desiccating) adsorbents such as, for example, silica gels, activated carbons, calcium sulfate, calcium chloride, non-zeolite molecular sieves or mixtures thereof.

### Additional Constituents of the Beads

The adsorbent beads can also be constructed of one or more additional constituents that are distinct from the one or more adsorbent materials. In such embodiments, the adsorbent beads 74 can be formed as a desiccant layer adjacent to the one or more additional constituents. An additional constituent of the adsorbent beads is, for example, a polymer binder component or an inorganic component.

The polymer binder constituent may contain any of a variety of organic polymers or combination of polymers. The polymer binder component can comprise one or more thermoplastic polymers. The polymer binder component can comprise a thermoplastic resin or wax or combination thereof. While the invention is not necessarily limited to any specific polymer binder compositions, polyolefin resins and/or waxes are preferred.

In a variety of embodiments, thermoplastic resins can have a melt flow index of at least about 5, and in some of those embodiments about 7-100 (ASTM D 1238-89 measured at 190 (degrees) as specified). In some instances, a thermoplastic resin having melt flow index of less than 0.5 can be used at lower zeolite loadings (e.g. 10 to 30 wt. %) or in combination with waxes or higher melt flow index resins. Waxes typically have weight average molecular weights on the order of 1000 to 10000. The polymer or combination of polymers is selected such that the mixture formed in combination with the adsorbent materials can be flowed or extruded at an appropriate temperature (for example, from 50° C.-450° C.) to form the beads.

In at least one embodiment, the one or more additional constituents can be an inorganic component including a wide variety of ceramic materials. In one embodiment the inorganic component is clay. Examples of useful clays are, for example, montmorillonite, kaolinite, bentonite, smectite, attapulgite, sepiolite or a mixture thereof.

In some instances, additives such as coloring agents, antistatic agents, scents, lubricants, antioxidants, etc. can be added to the adsorbent beads. Techniques disclosed in U.S. Pat. Nos. 4,295,994; 4,337,171; 4,414,111; 4,920,090; and 5,120,600 or any known technique may be used to form the adsorbent beads. Once the adsorbent beads are formed, they can be applied as layers to a desired substrate by any conventional technique or otherwise used as desired.

### Method

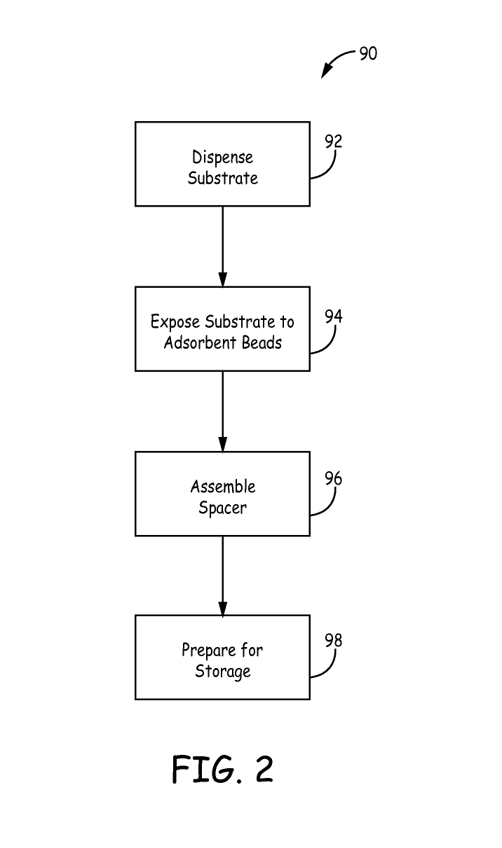

FIG. 2 depicts a flow chart consistent with one embodiment of the technology disclosed herein, particular to a method of forming a window spacer 90. Substrate is dispensed 92 and exposed to adsorbent beads 94. The spacer is assembled 96 and prepared for storage 98.

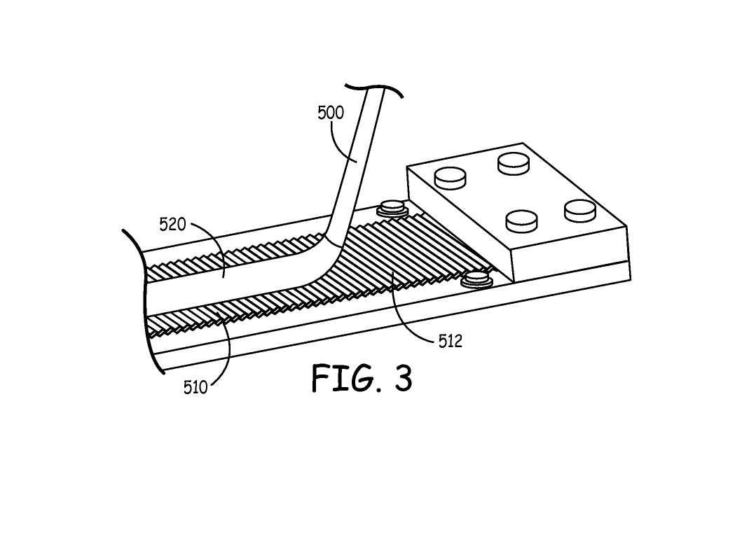

The substrate is dispensed 92 onto a surface of a first window spacer component. The substrate can be a variety of materials and combinations of materials, as discussed above. In at least one embodiment, dispensing substrate onto the surface includes feeding the window spacer component past a nozzle and dispensing the substrate through the nozzle. This will be described in more detail with reference to FIG. 3, below.

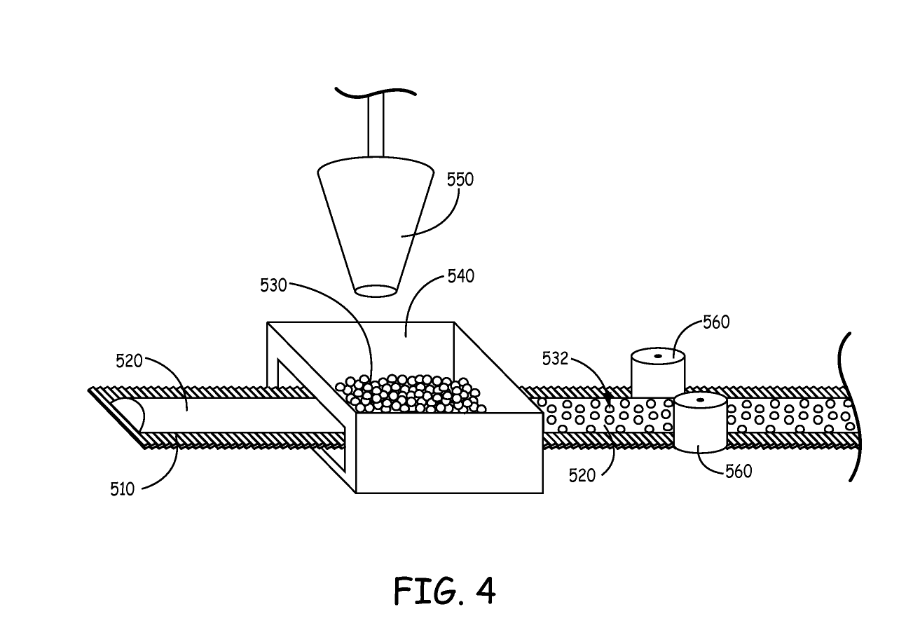

The substrate is exposed to a plurality of adsorbent beads 94 whereby a portion of the adsorbent beads adhere onto a surface of the substrate. In one embodiment, the window spacer component having the substrate disposed thereon is submerged in a plurality of adsorbent beads. In another embodiment, a stream of adsorbent beads is showered over the window spacer component and substrate whereby a portion of the adsorbent beads adhere onto the surface of the substrate. In yet another embodiment, a plurality of adsorbent beads are dispensed with the substrate through a nozzle onto the window spacer component. One embodiment consistent with exposing the substrate to a plurality of adsorbent beads 94 will be described with reference to FIG. 4.

In one alternate embodiment, a substrate is disposed directly on a plurality of adsorbent beads and then also adhered to a surface such as the interior surface of a window spacer. In such an embodiment, it can be desirable to use a substrate that is at least partially porous so as not to impede the utility of the adsorbent beads.

In a variety of embodiments it is desirable to improve the bonds between the adsorbent beads and the substrate. In one example, the plurality of adsorbent beads adhered to the substrate are passed against one or more rollers that provide a compressive force against a portion of the plurality of beads into the substrate, thereby partially embedding the adsorbent beads into the substrate. In some embodiments, the assembling of a second window spacer component to the first window spacer component provides a compressive force against a portion of the beads into the substrate.

In at least one embodiment, a combination of the above two approaches can be used to compress a substantial portion of the plurality of beads against the substrate, thereby partially embedding the plurality of adsorbent beads in the substrate and improving the bonds between the adsorbent beads and the substrate. Generally, the plurality of beads are no more than partially embedded in the substrate, meaning that, on average, no more than about 50% of each adsorbent bead is embedded in the substrate. In a variety of embodiments, no more than 40% of each adsorbent bead is embedded in the substrate, on average. As such, in those embodiments, at least 60% of each adsorbent bead is exposed, on average.

The spacer is assembled at step 96 of FIG. 2 to form a window spacer structure. Many different types of spacer structures are consistent with the technology disclosed herein, such as that depicted in FIGS. 1 and 6-9. In a variety of embodiments, sidewalls are extruded along the first elongate strip, and a second elongate strip is coupled to the extruded sidewalls. Other methods can also be used to assemble the window spacer 96.

In a variety of embodiments preparing the window spacer for storage 98 includes winding the window spacer onto a spool. The spool can then be stored, shipped, and the like. Other approaches to storing the window spacer can also be used.

FIG. 3 depicts a schematic of one process step consistent with dispensing substrate onto a surface of a first window spacer component. A first surface 512 of a first elongate strip 510 is fed past a nozzle 500, and the substrate 520 is dispensed through the nozzle 500 onto the first surface 512 of the first elongate strip 510. The substrate 520 can be a variety of materials and combinations of materials, as discussed above.

The first elongate strip 510 can be fed past the nozzle 500 through a variety of translation means generally known in the art. In one embodiment, the first elongate strip 510 is propelled through drive rollers that frictionally engage the first elongate strip 510. In another embodiment, the first elongate strip 510 is situated on a first conveyor belt that frictionally engages the first elongate strip 510 such that translation of the conveyor results in identical translation of the first elongate strip 510. In such an embodiment, an oppositely-facing conveyor belt can be used to frictionally engage the top surface of an elongate strip and translate identically to the first conveyor belt.

Generally the substrate 520 is dispensed through the nozzle 500 with the use of a pump. As such, the substrate 520 is generally a pump-able material. Those having skill in the art will appreciate that there are a number of pumps that can be used consistently with the current technology. In an alternate embodiment, the substrate 520 is a spray-able material, such as a foaming spray and, as such, the nozzle 500 dispenses the substrate through spraying.

FIG. 4 depicts another schematic of process steps consistent with exposing the substrate to a plurality of adsorbent beads. A first elongate strip 510 having a substrate 520 disposed thereon is submerged in a plurality of adsorbent beads 530 in a trough 540 and translated through the trough 540. Generally, the substrate 520 will be uncured so that a portion 532 of the plurality adsorbent beads 530 adheres to the surface of the substrate 520. In at least one embodiment a blower 550 is positioned in communication with the trough 540, where the blower 550 is configured to use air current to prevent adsorbent beads from translating out of the trough 540 and/or provide forces to keep the adsorbent beads moving within the trough to increase contact between adsorbent beads and the substrate 520.

In another embodiment, exposing substrate to a plurality of adsorbent beads can include translating the first elongate strip, having a substrate disposed thereon, past a stream of flowing adsorbent beads. A plurality of adsorbent beads can then adhere to the substrate upon impact. In such an embodiment the stream of flowing adsorbent beads can be through a nozzle or other similar component. In such an embodiment, a trough structure can be used to retain adsorbent beads that remain un-adhered to the substrate. In some such embodiment, those loose adsorbent beads can be re-routed to pass again through the nozzle (or similar structure). Other approaches to adhering adsorbent beads to the substrate are also contemplated.

In a variety of embodiments, adhering adsorbent beads to the substrate changes the cross-sectional shape of the substrate. For example, in an embodiment where the substrate has a rectangular cross-section, adhering the plurality of adsorbent beads to the substrate results in the substrate having a cross section that is a semi-circle, semi-oval, or another shape including irregular shapes.

After adhering adsorbent beads 532 to the substrate 520, it can be desirable to improve the bonds between the adsorbent beads and the substrate. The first elongate strip 510 is translated past drive rollers 560, where the drive rollers 560 are configured to translate at substantially the same speed as the first elongate strip 510 and are positioned to provide a compressive force against a portion of the adsorbent beads 532 into the substrate 520. In the current embodiment, the drive rollers 560 are positioned substantially normal to the length of the substrate 520, and on opposite sides of the substrate 520 relative to each other. In a variety of embodiments the plurality of adsorbent beads 532 remain on average no more than partially embedded in the substrate 520. In at least one embodiment, a third drive roller can be incorporated in the system to provide a compressive force on the top of the substrate 520 with adsorbent beads 532.

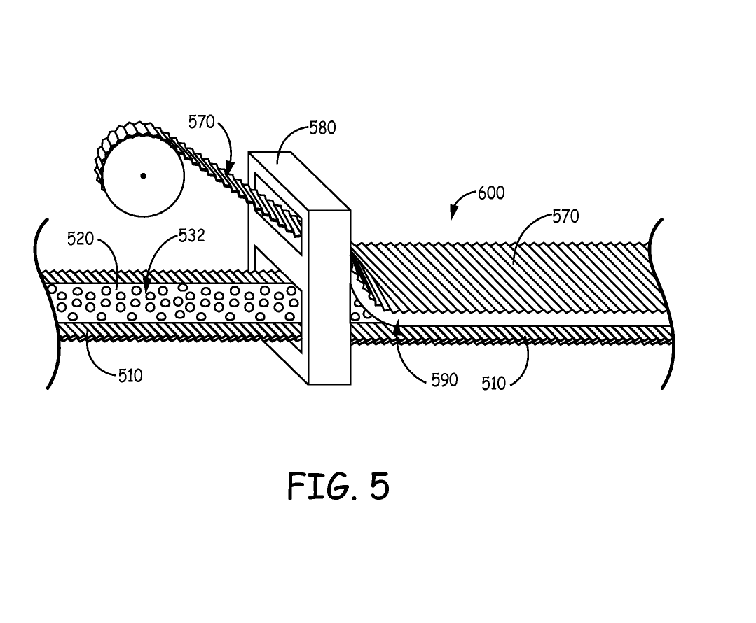

FIG. 5 depicts a schematic of additional process steps consistent with the technology disclosed herein. The first elongate strip 510 having substrate 520 disposed thereon and having a plurality of adsorbent beads 532 no more than partially embedded in the substrate 520 is fed through an extrusion die 580. A second elongate strip 570 consistent with those described above is also fed through the extrusion die 580, and longitudinal sidewalls 590 are extruded by the extrusion die 580 onto the second elongate strip 570.

The extrusion die 580 positions the second elongate strip 570 having the longitudinal sidewalls 590 and the first elongate strip 510 having the substrate 520 and adsorbent beads 532 so as to couple the longitudinal sidewalls 590 to the first elongate strip 510 to form a spacer 600. The extrusion die 580 additionally positions the second elongate strip 570 such that it exerts a compressive force on a portion of the adsorbent beads 532 into the substrate 520. The compressive force on the portion of adsorbent beads 532 improves the bonds between each of the adsorbent beads 532 and the substrate 520 and no more than partially embeds the adsorbent beads 532 on average in the substrate 520.

In a variety of embodiments, the first elongate strip 510 and/or the second elongate strip 570 are heated before entry to the extrusion die 580. In some embodiments, the first elongate strip 510 and the second elongate strip 570 are heated upon entry to the extrusion die 580.

In a variety of embodiments, the second elongate strip 570 is positioned on the adsorbent beads 532 and substrate 520 independent of the extrusion die 580. In one such embodiment the second elongate strip 570 is positioned on the adsorbent beads 532 and the substrate 520 and then the longitudinal sidewalls 590 are extruded by an extrusion die to be in contact with both the first elongate strip and the second elongate strip. In another such embodiment the longitudinal sidewalls 590 are extruded by an extrusion die on the first elongate strip 510 and then the second elongate strip 570 is positioned on the adsorbent beads 532, substrate 520, and the longitudinal sidewalls 590.

In a variety of embodiments, the extrusion die is not configured to position the second elongate strip so as to compress a portion of the adsorbent beads 532 in the substrate 520. In such embodiments, a third roller, as mentioned in the description of FIG. 4, above, can be used to improve the bond between the portion of adsorbent beads 532 at the top-most surface of substrate 520 on the first elongate strip 510. In some embodiments, the extrusion die extrudes the longitudinal sidewalls on the first elongate strip rather than the second elongate strip. In such embodiments the second elongate strip is then brought in contact with the longitudinal sidewalls to form the spacer 600. Other approaches are also contemplated.

Upon formation of the spacer structure 600, it can be desirable to cure the longitudinal sidewalls 590 and/or the substrate 520 having the plurality of adsorbent beads 532. In some embodiments the spacer structure is cooled using air or water. Those having skill in the art will appreciate that between various process steps in can be desirable to alternately provide heating or cooling to the existing portion of the spacer structure to prepare the spacer structure for upcoming process steps.

In at least one embodiment, the translation means discussed above with reference to FIG. 3 is implemented along a multi-stationed manufacturing line on the formed spacer structure 600 rather than just the first elongate strip 510. In such embodiments, translation of the spacer structure 600 results in equivalent translation of the first elongate strip 510 because the first elongate strip extends 510 across the manufacturing line from one or more stations associated with the process steps depicted in FIG. 3, to one or more stations associated with the process steps depicted in FIG. 4, to one or more stations associated with the process steps depicted in FIG. 5.

The spacer structure 600 can be prepared for storage in a number of ways. In a variety of embodiments, the spacer structure 600 is disposed about a spool.

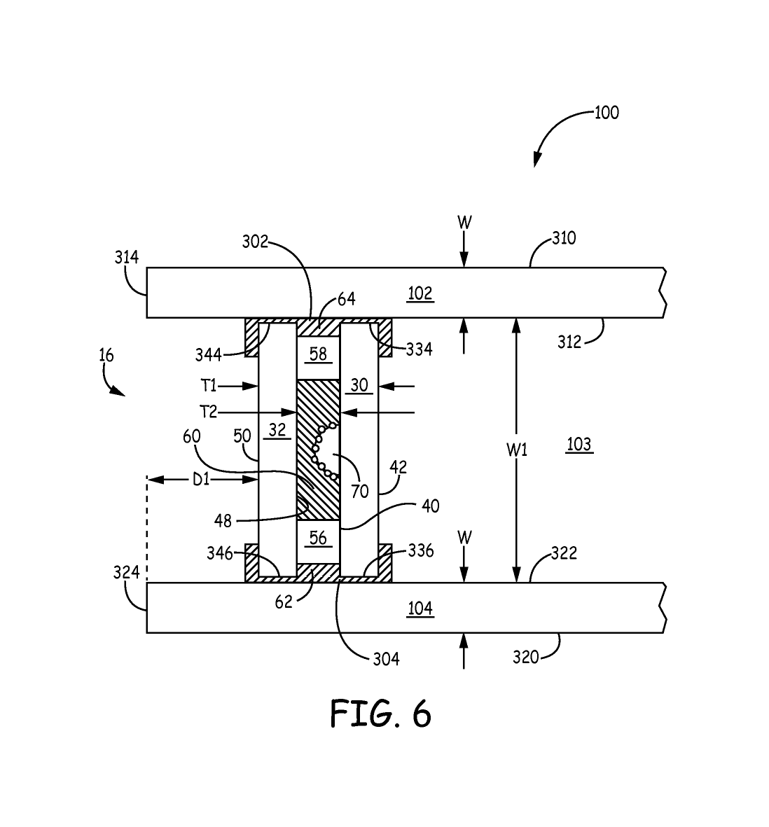

FIG. 6 depicts a schematic cross-sectional view of an example implementation of the spacer consistent with that depicted in FIG. 1. In this embodiment, window assembly 100 includes first pane 102, second pane 104, spacer 16, and also includes first sealant 302 and second sealant 304 disposed between the spacer 16 and each pane 102, 104. An interior space 103 is defined by the first pane 102, second pane 104, and the spacer 16.

The first pane 102 and the second pane 104 are generally made of a material that allows at least some light to pass through. Typically, the first pane 102 and the second pane 104 are made of a substantially planar, transparent material, such as glass, plastic, or other suitable materials. Alternatively, a translucent or semi-transparent material is used, such as etched, stained, or tinted glass or plastic. It is also possible for the first pane 102 and the second pane 104 to be opaque, such as decorative opaque sheets. In some embodiments the first pane 102 and the second pane 104 are the same type material. In other embodiments, the first pane 102 and the second pane 104 are different types of materials.

The first pane 102 defines an outer surface 310, inner surface 312, and perimeter 314. The second pane 104 also defines an outer surface 320, inner surface 322, and perimeter 324. W is the thickness of the first and second panes 102 and 104. W is typically in a range from about 0.05 inches to about 1 inch, and preferably from about 0.1 inches to about 0.5 inches. Other embodiments include other dimensions. While in the current embodiment the first and second panes 102, 104 have an equal width W, those having skill in the art will understand that, in at least one embodiment, the first and second panes 102, 104 can have unequal widths.

The spacer 16 is arranged between the inner surface 312 of the first pane 102 and the inner surface 322 of the second pane 104. The spacer 16 is typically arranged adjacent to the perimeters 314, 324 of the first and second panes 102, 104, respectively, and forms a closed loop. In the current embodiment, the first elongate strip 30 is considered the inner elongate strip because it is positioned inward relative to the perimeters of the first and second panes 102, 104 compared to the second elongate strip 32. Likewise, the second elongate strip 32 can be considered the outer elongate strip because it is positioned relatively outward relative to the perimeters of first and second panes 102, 104 compared to the first elongate strip 32. It will be appreciated that, in at least one other embodiment, spacer is inverted such that the first elongate strip 30 is positioned as the outer elongate strip and the second elongate strip 32 is positioned as the inner elongate strip.

In the embodiment of FIG. 6, the composition 70 is positioned on the inner elongate strip 30. In another embodiment, the composition 70 is positioned on the outer elongate strip 31.

D1 is the distance between perimeters 314 and 324 and spacer 106. D1 is typically in a range from about 0 inches to about 2 inches, and preferably from about 0.1 inches to about 0.5 inches. However, in other embodiments spacer 106 is arranged in other locations between sheets 102 and 104.

The spacer 16 is generally configured to maintain and substantially isolate the interior space 103 between the first pane 102 and the second pane 104. As such, in the current embodiment, W1 is the overall width of the spacer 16 and the distance between the first pane 102 and the second pane 104. W1 is typically in a range from about 0.1 inches to about 2 inches, and preferably from about 0.3 inches to about 1 inch. Other embodiments include other spaces.

When the window assembly 100 is fully assembled, a gas can be sealed within the interior space 103. In some embodiments, the gas is air. In some embodiments, the gas includes oxygen, carbon dioxide, nitrogen, or other gases. Yet other embodiments include an inert gas, such as helium, neon or a noble gas such as krypton, argon, xenon and the like. Combinations of these or other gases are used in other embodiments.

As discussed with reference to FIG. 1, the spacer 16 has a first elongate strip 30, a second elongate strip 32, a first longitudinal wall 56, and a second longitudinal wall 58, defining a cavity 60 there-between. A composition 70, as described with reference to FIGS. 1-1(c), above, is disposed within the spacer cavity 60. T1 is the overall thickness of spacer 16 from the second surface 42 of the first elongate strip 30 to the second surface 50 of the second elongate strip 32. T1 is typically in a range from about 0.02 inches to about 1 inch, and preferably from about 0.1 inches to about 0.5 inches. T2 is the distance between the first elongate strip 30 and the second elongate strip 32 and, more specifically, the distance from the first surface 40 of the first elongate strip 30 to the first surface 48 of the second elongate strip 32. T2 can be in a range from about 0.02 inches to about 0.5 inches, and in a variety of embodiments from about 0.05 inches to about 0.15 inches. As described with reference to FIG. 1, the first elongate strip 30 and/or the second elongate strip 32 can define undulations. As a result, T2 is an average thickness in a variety of embodiments.

In the current embodiment, sealant is used to couple the spacer 16 to the first pane 102 and the second pane 104. To form the first sealant 302, sealant can be applied along edges 334, 344 of the spacer 16, and within a first channel 62 adjacent to the first longitudinal sidewall 56. The spacer 16 and sealant can be pressed against the inner surface 312 of first pane 102. Likewise, to form the second sealant 304, sealant is also applied along edges 336, 346 of the spacer 16 and within a second channel 64 adjacent to the second longitudinal sidewall 58, and then the spacer 16 and the sealant is pressed against the inner surface 322 of the second pane 104. In other embodiments, beads of sealant 302 and 304 can be applied to the first pane 102 and the second pane 104 and the spacer 16 is then pressed into the beads.

Sealants 302 and 304 generally include one or more materials having adhesive properties, so as to fasten the spacer 16 to the first pane 102 and the second pane 104. Typically, the sealant 302 and 304 is arranged to the support spacer 16 is an orientation normal to the inner surfaces 312, 322 of the first pane 102 and the second pane 104, respectively. The sealant 302, 304 also generally seals the joint formed between the spacer 16 and the sheets 102, 104 to inhibit gas or liquid intrusion into the interior space 120 of the window assembly 100. Examples of the first sealant 302 and second sealant 304 include polyisobutylene (PIB), butyl rubber, curable PIB, silicon, adhesives from example acrylic adhesives, sealant for examples acrylic sealants, and other Dual Seal Equivalent (DSE) type materials.

First sealant 302 and second sealant 304 is illustrated as extending out from the edges of spacer 16, such that the first sealant 302 and second sealant 304 contacts the second surfaces 50, 42 of the first elongate strip 30 and second elongate strips 32. Such contact is not required in all embodiments. However, the additional contact area between first sealant 302 and the second sealant 304 and spacer 16 can be beneficial. For example, the additional contact area between the sealant and the spacer 16 increases adhesion strength. The increased thickness of the first sealant 302 and second sealant 304 can improve the moisture and gas barrier. In some embodiments, however, sealants 302 and 304 do not extend beyond external surfaces 330 and 340 of spacer 106.

FIG. 7 depicts a perspective view of a portion of another embodiment of a window assembly having a spacer having desiccant, consistent with the technology disclosed herein. This particular implementation is consistent with what will be referred to as a symmetrical triple pane window assembly.

Window assembly 106 includes a first pane 110, a second pane 120, an intermediary pane 130 and a spacer 140 disposed between the first pane 110 and the second pane 120. The first pane 110 defines a first surface 112, a second surface 114, and a perimeter 116. The intermediary pane 130 defines a third sheet surface 132, a fourth sheet surface 134, and a perimeter 136. The second pane 120 defines a fifth sheet surface 122, a sixth sheet surface 124, and a perimeter 126. FIG. 7 is a partial view of the window assembly 106 and depicts the spacer 140 disposed adjacent to the bottom perimeter 116 of the first pane 110 and the bottom perimeter 126 of the second pane 120. It should be understood that the spacer 140 is disposed between the first pane 110 and the second pane 120 adjacent to the entire perimeters of the sheets 110, 120 to form a closed loop.

Similar to the discussion of FIG. 6, the first pane 110, second pane 120 and intermediary pane 130 are generally made of a material that allows at least some light to pass through. In some embodiments the first pane 110, second pane 120 and intermediary pane 130 can be different materials or the same materials. In a variety of embodiments, there can be multiple intermediary panes. In at least one embodiment, there are two intermediary panes.

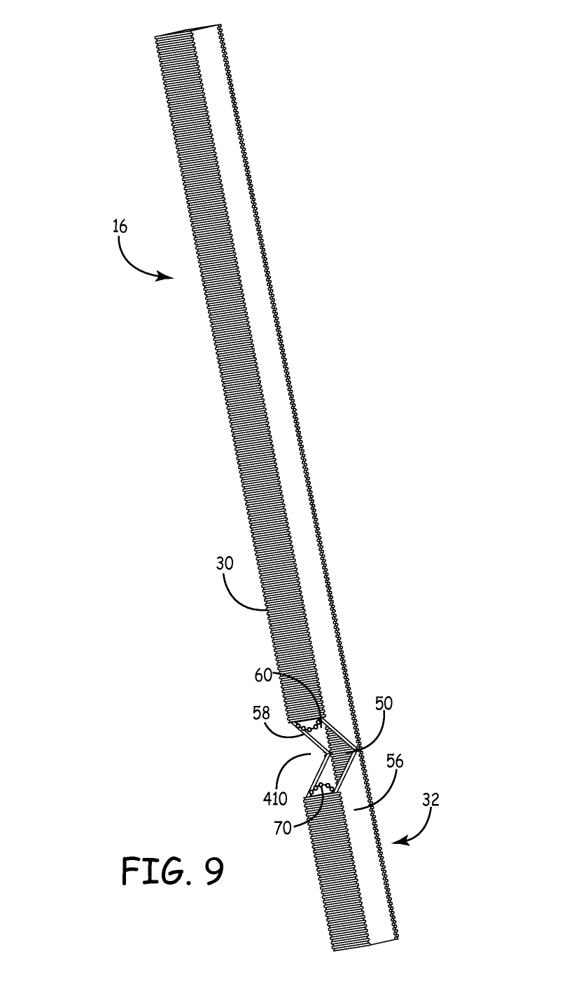

When the window assembly 106 is fully assembled, a gas can be sealed within a first air space 180, defined between the first pane 110 and the intermediary pane 130, and a second air space 190, defined between the second pane 120 and the intermediary pane 130. In embodiments where there are multiple intermediary sheets, additional air spaces will be defined. In some embodiments the air spaces will be is fluid communication, which is described below with reference to FIG. 9. In the current embodiment, the intermediary pane 130 is positioned to be approximately equidistant from the first pane 110 and the second pane 120, so the width of the first air space 180 is approximately equal to the size of the second air space 190.

Similar to the spacer described above, the currently-described spacer 140 includes a first elongate strip 150, a second elongate strip 160, and longitudinal sidewalls 170, which mutually define an interior cavity 172 that contains a composition 152. The composition 152 generally has a substrate 154 with a first surface 157 in contact with the first elongate strip 150 and a second surface 158 distinct from the first surface 157. A plurality of adsorbent beads 156 are, on average, no more than partially embedded in the second surface 158 of the substrate 154. Notably, in the current embodiment, the substrate has a substantially rectangular cross-section, so the second surface 158 includes three sidewalls of the rectangle, and the first surface 157 includes one sidewall of the rectangle. Also, the inner elongate strip is the second elongate strip 160 and the outer elongate strip is the first elongate strip 150.

The second elongate strip 160 of the spacer 140 defines a registration structure 166 that is configured to at least partially contact the perimeter 136 of the intermediary pane 130 between the first pane 110 and the second pane 120. In some embodiments, the registration structure 166 is configured to receive the perimeter of the intermediary pane 130. In the current embodiment, the registration structure 166 is a channel or depressed portion in the second elongate strip 160. The registration structure has a different configuration in other embodiments, such as a protrusion from the second elongate strip or a ledge. In some embodiments, the registration structure is integral with and formed by the second elongate strip. In some embodiments, the registration structure is elongate and continuous along the second elongate strip, as illustrated. In other embodiments, the registration structure is not continuous and is present intermittently along the second elongate strip. In embodiments of the current technology incorporating multiple intermediary sheets, multiple registration structures will be defined.

The spacer 140 is arranged to form a closed loop adjacent to the perimeters 116, 126 of at least the first pane 110 and second pane 120, and in a variety of embodiments also adjacent to the perimeter 136 of the intermediary pane 130. Spacer 140 is generally structured to withstand compressive forces applied to the first pane 110 and/or the second pane 120 to maintain a desired space between the panes 110, 120, 130. The first air space 180 is defined within window assembly 100 by the spacer 140, the first pane 110 and the intermediary pane 130. The second air space 190 is defined within the window assembly 100 by the spacer 140, the second pane 120, and the intermediary sheet 120.

Similar to the embodiment described above, channels 162 are defined between the elongate edges of the spacer 140 and the longitudinal sidewalls 170. Also similar to the embodiment described above, sealant is generally deposited within the channels 162 when assembling the window assembly 106 to couple the spacer 140 to the panes 110, 120 and so that gas and liquid are inhibited from entering the space disposed between the first and second sheets 110, 120. During assembly of a window unit, sealant or adhesive is also deposited along the registration structure to couple with the intermediary sheet 130. The intermediary sheet, spacer or both are manipulated in order to wrap the spacer around the perimeter edge of the intermediary sheet. The first and second sheets 110, 120 are brought into contact with the elongate edges of the spacer 140. During this step, the sealant or adhesive is under some pressure. This pressure helps to strengthen the bond between the sealant or adhesive material and the first and second panes 110, 120. Another effect of the pressure is that the material typically spills out of the channel slightly, thereby contacting the top and bottom surfaces of the elongate edges of the spacer 140 and providing a barrier at the juncture of the spacer 140 and the first and second panes 110, 120.

Recognizing that the undulations can be present in multiple embodiments, it is still possible to characterize portions of the elongate strips as planar in their overall shape, even when repeating undulations make up the planar structure. The first elongate strip 150 is substantially planar, and the second elongate strip 160 has planar regions 161 connected to neck-down regions 164 with a respective ramp 168. The second elongate strip 160 has neck-down regions 164 towards the elongate edges of the spacer 140, such that the height of the spacer 140 is lower along the elongate edges of the spacer 140, so that the first 150 and second 160 elongate strips are closer to each other. In one embodiment, the support legs 170 are positioned within the neck-down region 154.

The second elongate strip 160 defines a registration structure 166 that enables positioning of the intermediary pane 130 during the assembly process by providing a structure which the intermediary pane 130 can contact during the assembly process. The registration structure 166 is a channel having a base that has a width configured to accommodate the width of the intermediary pane 130 and at least one ramped surface leading to the base 167. During assembly, adhesive can be deposited on the surface of the base 167 and the intermediary pane 130 is positioned thereon. In some embodiments, the registration structure 166 includes two ramped surfaces, while in some embodiments there is only one ramped surface, and in other embodiments there are no ramped surfaces. While the registration structure 166 depicted in the current embodiment is a channel defined by the second elongate strip 160, registration structures can also include protrusions, openings, and combinations thereof that can also aid in positioning of the intermediary pane 130 during assembly. The channel of the registration structure 166 including ramped surfaces improves the ability to reel the spacer onto a spool compared to configurations having a protrusion or right-angle surfaces.

FIG. 8 depicts a partial perspective view of a portion of another implementation of a window assembly having a spacer having desiccant. This particular implementation is consistent with what will be referred to as an asymmetrical triple pane window assembly. The current implementation is similar to that described above with reference to FIG. 7, except that a first air space 280 defined by a spacer 240, a first pane 222, and an intermediary pane 232 is smaller than a second air space 290 defined by the spacer 240, the intermediary pane 232, and a second pane 212. In addition, compositions 252 disposed in a cavity 272 defined by the spacer 240 have a different configuration than those previously described.

In this example embodiment, a registration structure 266 defined by a second elongate strip 260 of a spacer 240 is defined closer to a first edge 256 of the spacer 240 than the opposite second edge 258 of the spacer. As such, the intermediary pane 232 is positioned closer to the first pane 222 than the second pane 212 and the width of the first air space 280 is smaller than the width of the second air space 290. Those having skill in the art will appreciate that variances in widths of the first air space 280 and the second air space 290 can influence insulation properties of the window assembly 200 depending on a variety of factors.

As mentioned above, the compositions 252 disposed in the spacer cavity 272 have a different configuration than the compositions previously described. In this embodiment, two compositions 252 are disposed within the spacer cavity 272. Each composition 252 has a substrate 253 with a semi-circular cross-section and a first surface 251 in contact with the first elongate strip 250. A plurality of adsorbent beads 254 are no more than partially embedded in a second surface 255 of the substrate 253, where the second surface 255 of the substrate 253 is distinct from the first surface 251 of the substrate 253.

It will be appreciated that additional desiccating compositions could be disposed within the spacer cavity. In addition, the desiccating compositions disposed within the spacer cavity can have different or similar shapes. Furthermore, it can be possible to use differing materials in each of the desiccating compositions disposed within the spacer cavity.

FIG. 9 depicts a perspective view of a portion of a spacer consistent with the technology disclosed herein. The spacer 16 is generally consistent with that depicted in FIGS. 1 and 6. The spacer 16 includes corner notches 410 at intervals along the length of the spacer 16 that correspond to anticipated corner locations of a window assembly.

The notches 410 are generally V-shaped. Each notch 410 extends through the first elongate strip 30, the first and second sidewalls 56, 58 and no more than partially through the first surface 40 of the second elongate strip 32. In embodiments consistent with the current Figure, the notch 410 will extend through the elongate strip that is intended as the inner elongate strip and will extend no more than partially through the elongate strip that is intended as the outer elongate strip

In the depicted embodiment, the notch 410 defines an angle that is about 90 degrees, although the angle of the corner notch 410 can have different measurements depending on the desired angle measurement of the resultant corner in the formed spacer frame. In one embodiment, the desiccating composition 70 is disposed along the entire at length of the first elongate strip 30, including at anticipated notch locations. In another embodiment, the desiccating composition 70 is disposed at intervals along the length of the first elongate strip 30 between anticipated notch locations.

In a variety of embodiments, the corner notching of the spacer 16 results in fluid communication between the spacer cavity 60 and the interior space 103 of the window assembly (See FIG. 6). In such embodiments, the assembled window assembly includes residual gaps at the corner locations, allowing gas and moisture to pass from the interior space of the window assembly through the second elongate strip 32 to the cavity 60 having the desiccating composition 70. As such, moisture located within the interior space is allowed to pass through the spacer 16 where it is removed by the desiccant in the composition 70.

Those having skill in the art will appreciate that the corner notching described above and depicted in FIG. 9 is applicable to window spacers used in window assemblies having more than two panes. As a result, and referring, for example, to FIG. 7, such corner notching can put the first air space 180 and the second air space 190 in fluid communication with the spacer cavity 172 and, as such, moisture located within the first air space 180 and the second air space 190 can be allowed to pass through the spacer 140 where it is removed by desiccant in the composition 158.

Although it is not pictured in the drawings, the inner elongate strip of the various embodiments described herein may define a plurality of apertures to allow gas and moisture to pass through the inner elongate strip or strips. As a result, moisture located within the air space or air spaces is allowed to pass into the spacer cavity where it is removed by desiccant in the composition. Where the composition is located on the inner elongate strip, the composition is positioned to not cover the apertures in one embodiment.

In some embodiments, neither elongate strip defines apertures, and desired airflow to the interior of the spacer cavity is achieved through the corner notches 210, as described herein.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like. The terms “sheet” and “pane” are also used interchangeably.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive.

We claim:

1. A composition comprising:
a) a layer of substrate having a first surface and a second surface distinct from the first surface; and
b) a plurality of adsorbent beads embedded in the second surface of the substrate, wherein each adsorbent bead of the plurality of adsorbent beads is no more than partially embedded in the second surface of the substrate and the substrate is substantially free of adsorbent beads.

2. The composition of claim 1, wherein the plurality of adsorbent beads are on average at least about 50% exposed.

3. The composition of claim 1, the substrate comprising a matrix material.

4. The composition of claim 1, the substrate comprising an inorganic material.

5. The composition of claim 1, wherein the first surface has a first surface area and the second surface has a second surface area, and the second surface area is greater than the first surface area.

6. The composition of claim 1, wherein the adsorbent beads comprise silica.

7. The composition of claim 1, wherein the adsorbent beads comprise zeolite.

8. The composition of claim 1, wherein the adsorbent beads comprise cyclodextrins.

9. The composition of claim 1, wherein the ratio of adsorbent beads to substrate is 1:1 by weight.

10. A window spacer comprising:
a) a spacer structure for an insulated glass unit, the spacer structure defining a cavity; and
b) a composition disposed within the cavity, the composition comprising:
a plurality of adsorbent beads, wherein each adsorbent bead of the plurality of adsorbent beads has a first portion having an outer surface in contact with air, and a second portion distinct from the first portion;
a substrate base layer comprising a substrate, wherein the substrate base layer is substantially free of adsorbent beads; and
an intermediate layer comprising:
the second portion of each adsorbent bead, and
the substrate.

11. The window spacer of claim 10, further comprising a first elongate strip, wherein the substrate has a first surface in contact with the first elongate strip and a second surface distinct from the first surface.

12. The window spacer of claim 11, wherein the first elongate strip comprises lateral undulations.

13. The window spacer of claim 11, wherein the surface area of the second surface is greater than the surface area of the first surface.

14. The window spacer of claim 11, further comprising a second elongate strip, a first longitudinal wall, and a second longitudinal wall, wherein the cavity is defined between the first elongate strip, the second elongate strip, the first longitudinal wall, and the second longitudinal wall.

15. A stored window spacer for an insulated glass unit containing a composition comprising:
a) a spool;
b) a spacer structure for an insulated glass unit, the spacer structure disposed about the spool and the spacer structure defining a cavity;
c) a composition disposed in the cavity, the composition comprising:
1) a layer of a substrate having a first surface;
2) a layer of adsorbent beads substantially fixed to the first surface of the substrate, the adsorbent beads comprising an adsorbent material, wherein the adsorbent material is substantially free of substrate and the substrate is substantially free of adsorbent material.

16. The window spacer of claim 15, further comprising a first elongate strip, wherein the substrate has a first surface in contact with the first elongate strip and a second surface distinct from the first surface.

17. The window spacer of claim 16, further comprising a second elongate strip, a first longitudinal wall, and a second longitudinal wall, wherein the cavity is defined between the first elongate strip, the second elongate strip, the first longitudinal wall, and the second longitudinal wall.

18. The window spacer of claim 16, wherein the first elongate strip defines lateral undulations.

19. The window spacer of claim 15, wherein the adsorbent beads comprise an inorganic material.

20. A method for forming a window spacer containing a composition comprising
a) dispensing substrate onto a surface of a first window spacer component;
b) exposing the substrate to a plurality of adsorbent beads whereby a portion of the adsorbent beads adhere onto a surface of the substrate; and
c) winding the window spacer onto a spool.

21. The method of claim 20, further comprising passing the adsorbent beads adhered to the substrate against a roller.

22. The method of claim 20, wherein dispensing substrate onto a surface further comprises feeding the window spacer component past a nozzle and dispensing the substrate through the nozzle.

23. The method of claim 20, further comprising forming a window spacer structure.

24. The method of claim 20, wherein exposing the substrate to a plurality of adsorbent beads comprises submerging the substrate in the plurality of adsorbent beads.

25. The method of claim 20, further comprising pressing a second window spacer component on the adsorbent beads adhered to the substrate.
